(19) United States
(12) Patent Application Publication
(10) Pub. No.: US 2023/0367120 A1
(43) Pub. Date: Nov. 16, 2023

(54) VEHICLE DISPLAY APPARATUS

(71) Applicant: YAZAKI CORPORATION, Tokyo (JP)

(72) Inventors: Naohisa Murata, Makinohara-shi (JP); Kotaro Mizuno, Shimada-shi (JP); Takuya Ishigami, Shimada-shi (JP)

(21) Appl. No.: 18/300,398

(22) Filed: Apr. 14, 2023

(30) Foreign Application Priority Data
May 11, 2022 (JP) 2022-077957

(51) Int. Cl. G02B 27/01; G02B 17/08; B60K 35/00

(52) U.S. Cl. CPC G02B 27/0101; G02B 17/08; B60K 35/00; G02B 2027/0118; B60K 2370/1529

(57) ABSTRACT

A vehicle display apparatus includes: an image display device that includes a display surface that displays an image; a lens member that is arranged facing the display surface; and an optical system that includes a mirror and forms, using the mirror, an optical path from the lens member to a reflection surface on a windshield. The lens member includes an incident surface that faces the display surface and an emission surface that emits display light of the image toward the mirror. When viewed from an image horizontal direction, the lens member is tapered with a thickness from the incident surface to the emission surface being reduced toward one side in an image vertical direction. When viewed from the image horizontal direction, the display surface is inclined relative to a direction orthogonal to the optical path of the display light emitted from the emission surface to the mirror.

### CROSS-REFERENCE TO RELATED APPLICATION(S)

The present application claims priority to and incorporates by reference the entire contents of Japanese Patent Application No. 2022-077957 filed in Japan on May 11, 2022.

### BACKGROUND OF THE INVENTION

### 1. Field of the Invention

The present invention relates to a vehicle display apparatus.

### 2. Description of the Related Art

Conventionally, there is a technology of displaying an image in an inclined manner. Japanese Patent Application Laid-open No. 2017-194556 discloses a virtual image display apparatus including a transmission-type display unit that modulates illumination light to generate display light, and a drive unit that rotates the display unit so that the display unit is inclined with respect to the optical axis of the illumination light, and the virtual image display apparatus is configured to project the display light onto a virtual display presentation surface to present a virtual image.

The inclination of a display surface of an image for achieving inclination display may cause reduction of contrast in the image. For example, if the inclination angle of the display surface is increased to improve the sense of three-dimensionality and depth, the contrast tends to be reduced. It is desired to display inclined images with appropriate contrast.

### SUMMARY OF THE INVENTION

The present invention aims at providing a vehicle display apparatus capable of displaying inclined images with appropriate contrast.

In order to achieve the above mentioned object, a vehicle display apparatus according to one aspect of the present invention includes an image display device that includes a display surface that displays an image; a lens member that is arranged facing the display surface; and an optical system that includes at least one mirror and forms, using the mirror, an optical path from the lens member to a reflection surface on a windshield of a vehicle, wherein the lens member includes an incident surface that faces the display surface and an emission surface that emits display light of the image toward the mirror, when viewed from an image horizontal direction, the lens member is tapered with a thickness from the incident surface to the emission surface being reduced toward one side in an image vertical direction, and when viewed from the image horizontal direction, the display surface is inclined relative to a direction orthogonal to the optical path of the display light emitted from the emission surface to the mirror.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is an arrangement diagram of a vehicle display apparatus according to an embodiment;

FIG. 2 is a schematic configuration diagram of the vehicle display apparatus according to the embodiment;

FIG. 3 is a perspective view of a lens member according to the embodiment;

FIG. 4 is a diagram illustrating an image display device and the lens member according to the embodiment; and

FIG. 5 is a diagram illustrating a display unit according to a comparative example.

### DETAILED DESCRIPTION OF THE PREFERRED EMBODIMENTS

The following will specifically describe a vehicle display apparatus according to an embodiment of the present invention with reference to the drawings. The invention is not limited by the embodiment. The components in the following embodiment include those that are easily assumed by those skilled in the art or are substantially the same.

### Embodiment

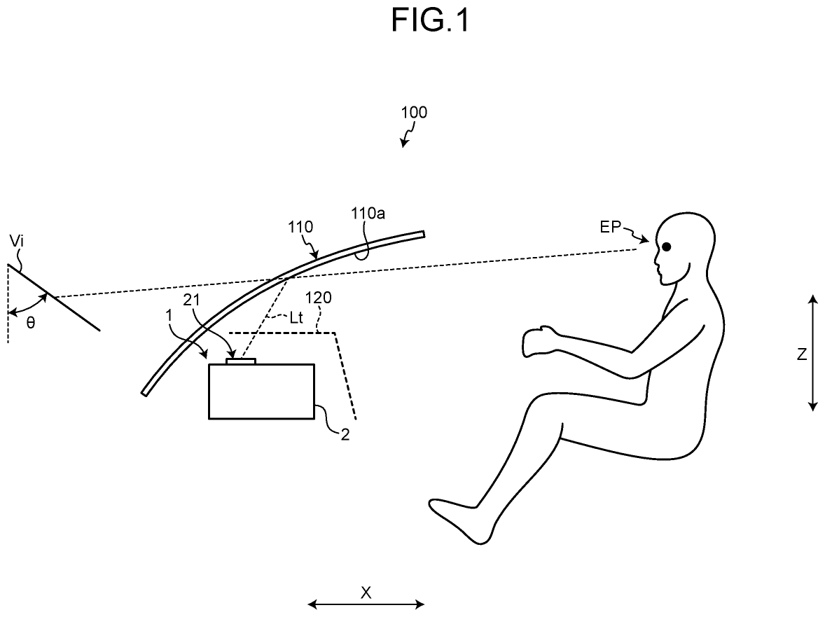

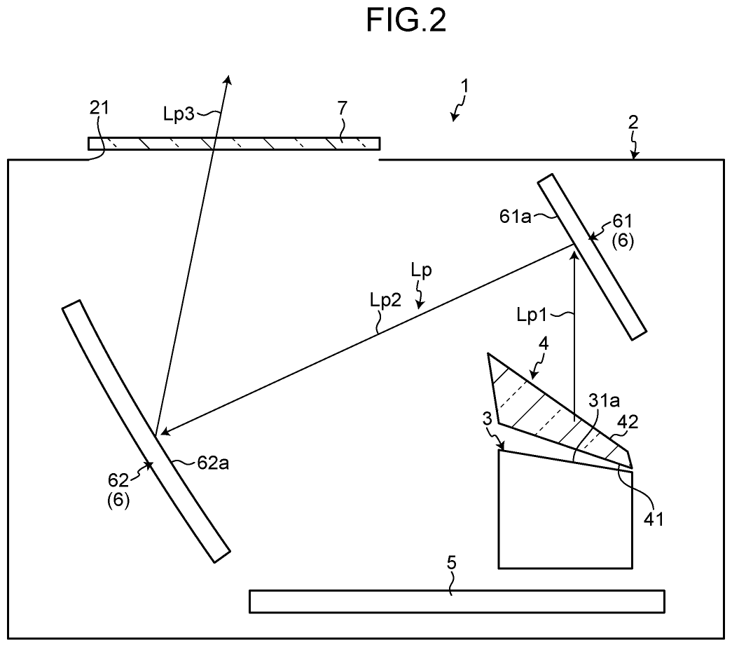

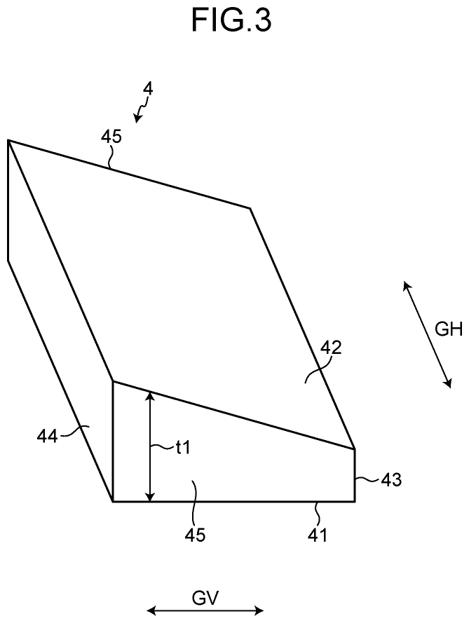

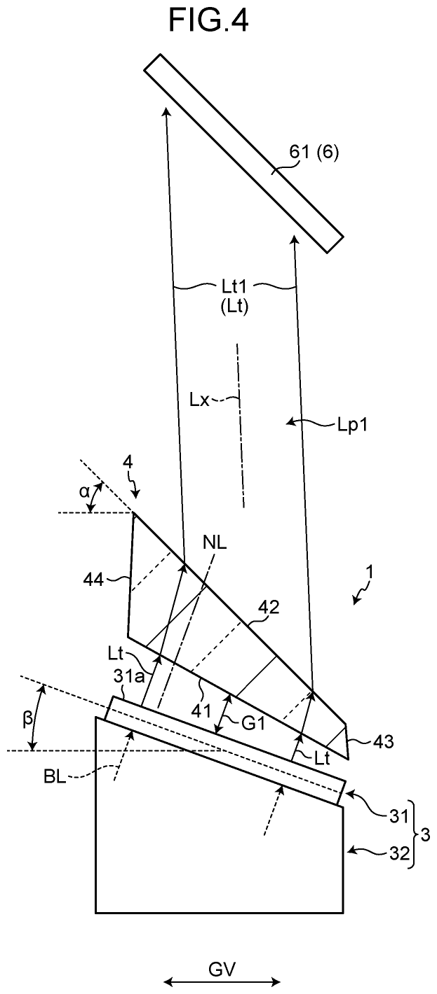

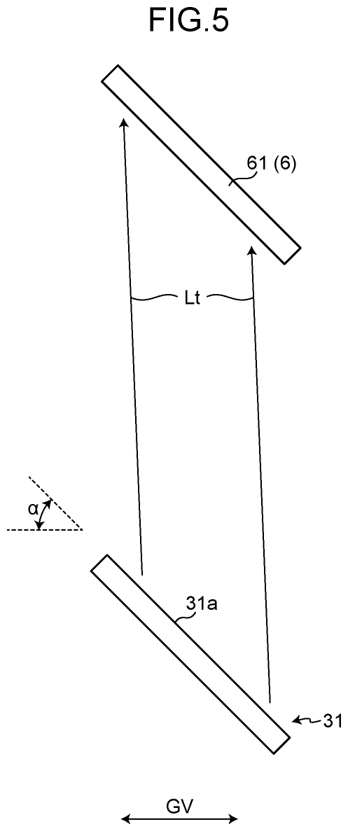

An embodiment will be described with reference to FIG. 1 to FIG. 5. The embodiment relates to a vehicle display apparatus. FIG. 1 is an arrangement diagram of a vehicle display apparatus according to the embodiment; FIG. 2 is a schematic configuration diagram of the vehicle display apparatus according to the embodiment; FIG. 3 is a perspective view of a lens member according to the embodiment; FIG. 4 is a diagram illustrating an image display device and the lens member according to the embodiment; and FIG. 5 is a diagram illustrating a display unit according to a comparative example.

As illustrated in FIG. 1, a vehicle display apparatus 1 of the embodiment is a head-up display apparatus provided in a vehicle 100 such as an automobile. The vehicle display apparatus 1 projects display light Lt of an image toward a windshield 110. The windshield 110 is positioned on the vehicle front side with respect to an eye point EP of the vehicle 100, and faces the eye point EP in the front-rear direction X of the vehicle. The display light Lt is reflected toward the eye point EP by a reflection surface 110a on the windshield 110. A driver of the vehicle 100 is able to visually recognize a virtual image Vi by the display light Lt.

The virtual image Vi may be superimposed on an object in front of the vehicle 100 and displayed. As an example, the virtual image Vi is superimposed on a road surface in front of the vehicle 100. The virtual image Vi may be an image with characters and arrows for route guidance, for example.

The virtual image Vi displayed by the vehicle display apparatus 1 of the embodiment is an inclined image that is inclined relative to the vertical direction Z of the vehicle. When viewed from the horizontal direction of the image, the virtual image Vi is inclined at an inclination angle θ relative to the vertical direction Z of the vehicle. The virtual image Vi illustrated in FIG. 1 is inclined such that a distance of the virtual image Vi from the eye point EP becomes farther toward the upper side in the vertical direction of the image. That is, the vehicle display apparatus 1 performs inclination display so that the imaging distance relative to the eye point EP is larger at the image upper end than at the image lower end. With the display of an inclined image, the vehicle display apparatus 1 is able to perform superimposed display without discomfort in the foreground of the vehicle 100.

As illustrated in FIG. 1 and FIG. 2, the vehicle display apparatus 1 includes a housing 2, an image display device 3, a lens member 4, a control unit 5, an optical system 6, and a cover 7. The housing 2 is arranged on the front side of the vehicle with respect to the eye point EP, and is housed in an instrument panel 120, for example. The housing 2 is formed of a light-shielding material. The housing 2 includes an opening 21 facing the windshield 110 in the vertical direction of the vehicle. The illustrated opening 21 is arranged on the upper surface of the housing 2, and is positioned at the front end of the housing 2.

The image display device 3, the lens member 4, the control unit 5, and the optical system 6 are arranged in the housing 2. The image display device 3 is a device that outputs the display light Lt of an image. The image display device 3 includes a display unit 31 and a backlight unit 32, as illustrated in FIG. 4. The display unit 31 includes a display surface 31a that displays images. The display unit 31 is, for example, a liquid crystal display device such as a thin film transistor-liquid crystal display (TFT-LCD).

The backlight unit 32 is arranged on the back side of the display unit 31. The image display device 3 generates the display light Lt using the light of the backlight unit 32. The display unit 31 and the backlight unit 32 are controlled by the control unit 5.

The optical system 6 forms an optical path Lp from the lens member 4 to the reflection surface 110a on the windshield 110 of the vehicle 100. The optical system 6 illustrated in FIG. 2 includes a first mirror 61 and a second mirror 62. The optical path Lp includes optical paths Lp1, Lp2, and Lp3. The optical path Lp1 is an optical path from an emission surface 42 of the lens member 4 to the first mirror 61. The optical path Lp2 is an optical path from the first mirror 61 to the second mirror 62. The optical path Lp3 is an optical path from the second mirror 62 to the reflection surface 110a on the windshield 110 through the cover 7.

Each of the first mirror 61 and the second mirror 62 is a reflection member that reflects the display light Lt. The first mirror 61 includes a reflection surface 61a. The reflection surface 61a is flat, for example. The second mirror 62 includes a reflection surface 62a. The reflection surface 62a is a concave free curved surface, for example. The reflection surface 62a on the second mirror 62 is formed to enlarge images. The reflection surface 62a is also formed to correct image distortion and aberration. Furthermore, the reflection surface 62a of the embodiment is formed to incline images.

The first mirror 61 is arranged facing the image display device 3, and reflects the display light Lt toward the second mirror 62. The second mirror 62 reflects the display light Lt toward the cover 7 arranged at the opening 21. The cover 7 is formed of a transparent material such as synthetic resin, in a plate shape. The display light Lt transmitted through the cover 7 is reflected by the reflection surface 110a on the windshield 110 toward the eye point EP.

The lens member 4 is arranged facing the display surface 31a of the image display device 3. The lens member 4 is arranged on the side of the first mirror 61 with respect to the display surface 31a, and is positioned in the vicinity of the display surface 31a. The lens member 4 is formed of a transparent material such as synthetic resin. As illustrated in FIG. 3, the lens member 4 has a wedge shape. The lens member 4 includes an incident surface 41, the emission surface 42, a first end surface 43, a second end surface 44, and a pair of side surfaces 45.

The incident surface 41 is a surface on which the display light Lt output from the display surface 31a is incident. The emission surface 42 is a surface from which the display light Lt is emitted toward the first mirror 61. The incident surface 41 and the emission surface 42 are directed to the directions opposite to each other. The first end surface 43 and the second end surface 44 are positioned at the ends in the image vertical direction GV of the lens member 4. The first end surface 43 is positioned on the image upper side of the virtual image Vi, and the second end surface 44 is positioned on the image lower side of the virtual image Vi. That is, the first end surface 43 is the upper end surface in the vertical direction of the virtual image Vi, and the second end surface 44 is the lower end surface in the vertical direction of the virtual image Vi. The first end surface 43 and the second end surface 44 are flat, for example.

The lens member 4 is tapered with the thickness t1 being reduced toward the first end surface 43 along the image vertical direction GV. That is, when viewed from the image horizontal direction GH, the lens member 4 is tapered with the thickness t1 being reduced toward the upper side in the image vertical direction GV. The thickness t1 is a thickness from the incident surface 41 to the emission surface 42. The thickness direction is a direction orthogonal to the incident surface 41, for example.

The incident surface 41 and the emission surface 42 may be flat or curved. The incident surface 41 and the emission surface 42 may be free curved surfaces that corrects aberration. The side surfaces 45 are positioned at both ends in the image horizontal direction GH of the lens member 4. The side surfaces 45 are flat, for example.

FIG. 4 illustrates the image display device 3, the lens member 4, and the first mirror 61 when viewed from the image horizontal direction GH. As illustrated in FIG. 4, the lens member 4 is arranged such that the incident surface 41 faces the display surface 31a on the image display device 3. The lens member 4 is arranged such that the incident surface 41 covers the entire of the display surface 31a entire, for example. In this case, the entire display light Lt toward the eye point EP can be transmitted through the lens member 4. In other words, the entire virtual image Vi can be inclined by the lens member 4.

A gap may be provided between the incident surface 41 and the display surface 31a. The incident surface 41 may be inclined relative to the display surface 31a or parallel thereto. The illustrated lens member 4 is arranged such that the incident surface 41 is inclined relative to the display surface 31a. The lens member 4 is arranged so that a gap G1 between the display surface 31a and the incident surface 41 increases from the first end surface 43 toward the second end surface 44, for example.

The lens member 4 refracts the display light Lt between the display surface 31a and the first mirror 61. To be more specific, when viewed from the image horizontal direction GH, the lens member 4 inclines the display light Lt relative to the normal line NL of the display surface 31a. When the display light Lt along the normal line NL enters the incident surface 41, the display light Lt is refracted at each of the incident surface 41 and the emission surface 42, and is emitted toward the first mirror 61. In the following description, the display light Lt emitted from the emission surface 42 toward the first mirror 61 is referred to as emitted light Lt1.

As illustrated in FIG. 4, the optical axis Lx of the emitted light Lt1 is inclined relative to the normal NL of the display surface 31a. In the illustrated lens member 4, the emission surface 42 is inclined at a first angle α. The display surface 31a on the image display device 3 is inclined at a second angle β. The first angle α and the second angle β are the angles viewed from the image horizontal direction GH. The first angle α and the second angle β are inclination angles relative to the direction orthogonal to the optical axis Lx of the emitted light Lt1. The first angle α is also an inclination angle of the normal of the emission surface 42 relative to the optical axis Lx. The second angle β is also an inclination angle of the normal NL of the display surface 31a relative to the optical axis Lx.

The first angle α is larger than the second angle β. The vehicle display apparatus 1 of the embodiment is able to achieve the same inclination display as when the display surface 31a is inclined at the first angle α. There is considered, as a comparative example, a configuration in which the display surface 31a is inclined at the first angle α so as to realize an inclination angle θ of the virtual image Vi, as illustrated in FIG. 5. In the comparative example, a large inclination angle of the display surface 31a reduces the contrast of the display light Lt and the luminance of the display light Lt.

Meanwhile, with the lens member 4 of the embodiment, the second angle β, which is an inclination angle of the display surface 31a, can be reduced. That is, with respect to the inclination angle θ of the virtual image Vi, the required inclination angle of the display surface 31a can be reduced. Therefore, the vehicle display apparatus 1 of the embodiment is able to display the virtual image Vi in an inclined manner with appropriate contrast.

The control unit 5 displays, on the display surface 31a, an image to be superimposed on the foreground of the vehicle 100. The image displayed on the display surface 31a is, for example, an image expressing the sense of three-dimensionality and depth. The image is a perspective image formed in perspective, for example. The combination of a perspective image and inclination display improves the sense of three-dimensionality and depth of the virtual image Vi.

As described above, the vehicle display apparatus 1 of the embodiment includes the image display device 3, the lens member 4, and the optical system 6. The image display device 3 includes the display surface 31a that displays images. The lens member 4 is arranged facing the display surface 31a. The optical system 6 includes the first mirror 61 and the second mirror 62, and forms, using the mirrors 61 and 62, the optical path Lp from the lens member 4 to the reflection surface 110a on the windshield 110.

The lens member 4 includes the incident surface 41 that faces the display surface 31a, and the emission surface 42 that emits the display light Lt of an image toward the first mirror 61. When viewed from the image horizontal direction GH, the lens member 4 is tapered with the thickness t1 from the incident surface 41 to the emission surface 42 being reduced toward one side in the image vertical direction GV. When viewed from the image horizontal direction GH, the display surface 31a is inclined relative to the direction orthogonal to the optical path Lp1 of the display light Lt emitted from the emission surface 42 toward the first mirror 61.

The vehicle display apparatus 1 of the embodiment refracts the display light Lt by the lens member 4 having a tapered shape along the image vertical direction GV. The lens member 4 is able to achieve the same inclination display as when the inclination angle of the display surface 31a is larger than the second angle β. Therefore, the vehicle display apparatus 1 of the embodiment is able to display the virtual image Vi in an inclined manner with appropriate contrast.

In the vehicle display apparatus 1 of the embodiment, when viewed from the image horizontal direction GH, the inclination angle of the emission surface 42 relative to the direction orthogonal to the optical path Lp1 is larger than the inclination angle of the display surface 31a relative to the direction orthogonal to the optical path Lp1. Therefore, it is possible to reduce the inclination angle of the display surface and secure the appropriate contrast of the virtual image Vi.

The image display device 3 is not limited to a device that generates the display light Lt using light of the backlight unit 32. The image display device 3 may be an organic electro-luminescence (EL) display, for example. The image display device 3 is not limited to a device that generates images by a liquid crystal. The image display device 3 may be, for example, a device that generates images on a transmission-type screen using laser light or the like.

The inclination direction of the virtual image Vi is not limited to the inclination direction illustrated in FIG. 1. The inclination direction of the virtual image Vi may be a direction where a distance of the virtual image Vi from the eye point EP becomes closer toward the upper side in the vertical direction of the image. In this case, the inclination directions of the display surface 31a and the emission surface 42 are opposite from those in FIG. 4.

The contents disclosed in the above-described embodiments may be appropriately combined and implemented.

A vehicle display apparatus of the present embodiment includes: an image display device that includes a display surface; a lens member that is arranged facing the display surface; and an optical system that forms, using the mirror, an optical path from the lens member to a reflection surface on a windshield of a vehicle, in which when viewed from an image horizontal direction, the lens member is tapered with a thickness from the incident surface to the emission surface being reduced toward one side in an image vertical direction, and when viewed from the image horizontal direction, the display surface is inclined relative to a direction orthogonal to an optical path of the display light emitted from the emission surface to the mirror. The vehicle display apparatus of the invention has the effect of displaying inclined images with appropriate contrast by suppressing the inclination angle of the display surface.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display apparatus, comprising:
an image display device that includes a display surface that displays an image;
a lens member that is arranged facing the display surface; and
an optical system that includes at least one mirror and forms, using the mirror, an optical path from the lens member to a reflection surface on a windshield of a vehicle, wherein
the lens member includes an incident surface that faces the display surface and an emission surface that emits display light of the image toward the mirror,
when viewed from an image horizontal direction, the lens member is tapered with a thickness from the incident surface to the emission surface being reduced toward one side in an image vertical direction, and
when viewed from the image horizontal direction, the display surface is inclined relative to a direction orthogonal to the optical path of the display light emitted from the emission surface to the mirror.

2. The vehicle display apparatus according to claim 1, wherein
when viewed from the image horizontal direction, an inclination angle of the emission surface relative to the direction orthogonal to the optical path is larger than the inclination angle of the display surface relative to the direction orthogonal to the optical path.
